(19) United States
(12) Patent Application Publication
(10) Pub. No.: US 2003/0061166 A1
(43) Pub. Date: Mar. 27, 2003

(54) Security management apparatus, security management method, and security management program

(76) Inventors: Masahiro Saito, Kawasaki (JP); Michisaburou Kihara, Kawasaki (JP); Shigeaki Oura, Kawasaki (JP); Kayo Mizutani, Kawasaki (JP); Satoko Ono, Kawasaki (JP)

Correspondence Address: STAAS & HALSEY LLP, 700 11TH STREET, NW, SUITE 500, WASHINGTON, DC, 20001, US

(21) Appl. No.: 10/057,865

(22) Filed: Jan. 29, 2002

(30) Foreign Application Priority Data
Sep. 26, 2001 (JP) 2001-293132

(51) Int. Cl. G06F 17/60; H04K 1/00; H04L 9/00

(52) U.S. Cl. 705/54

(57) ABSTRACT

A security management apparatus, a security management method and a security management program are provided which are capable of performing access control to files, folders, etc., according to a current position of a prescribed device such as a portable terminal to be managed, In order to perform security control on a portable terminal, etc., security levels of the portable terminal are stored in advance in a predetermined table in association with the positions of the portable terminal. The current position of the portable terminal is detected by means of a GPS or the like, and a security level corresponding to the current position of the portable terminal detected is acquired from the predetermined table, so that booting of programs and/or access control to files, folders, etc., in the portable terminal are carried out based on the security level thus acquired.

### BACKGROUND OF THE INVENTION

1. Field of the Invention

The present invention relates to a security management apparatus, a security management method and a security management program for managing the security of a prescribed device. More particularly, the present invention relates to a security management apparatus, a security management method and a security management program for performing security control on invocation of programs such as an operating system (OS) and others, access to files, etc., for example, in a portable personal computer under operation, depending upon the geographical position thereof.

2. Description of the Prior Art

Computers in general have a function of protecting security in such a manner that a BIOS requests a password from a user upon booting an OS, thereby limiting the booting of the OS by means of the password input by the user. Also, current computers have other security functions as follows: that is, a password is requested from a user when he or she logs in to the OS, whereby logging in to the OS is limited by the password thus input, or access rights are set to files beforehand so that access to the files can be limited by the authority of the login user.

However, in such a known technique, after the OS of a portable personal computer has been booted for instance, access to the files becomes possible according to the user's right or authority until the login user logs off from the computer. Therefore, in cases where the portable personal computer has been stolen in a state of logging in for example, there arises a problem that even if an access limitation is set to files, a third party would be able to illegally access the files. Moreover, even where a user, who has the access right to the files in a portable personal computer, logs in to the computer and uses it, there is a fear that when using the computer in a train or the like during commutation, the user might open, by mistake, a file containing secret matters, etc., which might be viewed by a third party, thus allowing leakage of the secret information.

In order to avoid such a problem, in the past, when the user temporarily stops using the portable personal computer, goes away from his or her seat for a while and then comes back to use the computer again, it has been common that the portable personal computer is once powered off and then restarted, or the OS is once terminated or logged off and then rebooted or logged in again, thus preventing illegal or unauthorized access of the third party. In addition, when moving from one place to another place, the user has to similarly carry out some processing such as relogging in, etc. However, it is very troublesome and time-consuming that the user frequently performs such processing. Moreover, security control is left to the user, and hence security management becomes loose or vulnerable to tapping.

### SUMMARY OF THE INVENTION

The present invention is intended to obviate the problems as referred to above, and has for its object to provide a security management apparatus, a security management method and a security management program which have an improved security function by changing the user's right or authority to boot an OS, access files, etc., in accordance with the geographical position in which a portable personal computer is operating, for example, by permitting a user to boot an OS, access files, etc., only in a specific area such as the premises of a company for which the user is working, and which can reduce the user's work such as rebooting of the OS, relogging in, etc., which has been conventionally performed every time the user moves from one place to another.

In order to solve the above-mentioned problems, according to a first aspect of the present invention, there is provided a security management apparatus for managing the security of a prescribed device, the apparatus comprising: a position detecting section detecting a position of the prescribed device; and a control unit changing a security level of the prescribed device according to the position of the prescribed device detected by the position detecting section.

With this configuration, it is possible to permit an OS of the prescribed device such as, for example, a portable personal computer, etc., to be booted or files thereof to be accessed when the prescribed device exists in a specific area alone, while making it impossible to boot the OS and/or access the files when the prescribed device has moved out of the specific area. Thus, the security function of the prescribed device can be improved to a substantial extent. In an embodiment of the present invention, the above-mentioned position detecting section corresponds to a position detector. Here, note that a technology to detect the position of the prescribed device may be a position detecting function of a global positioning system (GPS) or a personal handyphone system (PHS), and it is not specifically limited in any manner. In addition, in an embodiment of the present invention, the security levels correspond to the kinds of access rights, and the control unit comprises a control section and a security setting switching section.

In a preferred form of the present invention, the security management apparatus further comprises a security information storing section storing Ago security levels of the prescribed device in association with positions of the prescribed device, wherein the control unit changes the security level of the prescribed device into one of the security levels stored in the security information storing section based on the position of prescribed device detected by the position detecting section. Thus, by storing the security levels in association with the positions of the prescribed device in this manner, the security level of the prescribed device can be freely changed based on the stored information, whereby the security level changing processing can be carried out with ease.

In another preferred form of the present invention, the security levels stored in the security information storing section are associated with users, and the control unit changes the security level of the prescribed device into one of the security levels stored in the security information storing section based on the position of the prescribed device detected by the position detecting section and one of the users. In an embodiment of the present invention, the positions of the prescribed device and group names corresponding to the users are stored in the security information table, so that the security setting switching section can acquire and set a group name to which the one of the users belongs, based on the position of the prescribed device and the name of the one user while referring to the security information table. The OS of the prescribed device acquires the kinds of the access rights based on the group name thus set by referring to the access right setting table, and performs the security control based on the acquired access rights. By performing the security management according to the position of the prescribed device and the user in this manner, the security function of the prescribed device can be improved, thus making it possible to carry out fine control on the security of the prescribed device.

In a further preferred form of the present invention, the security management apparatus has a login function capable of inputting and setting the users as corresponding user identifiers.

With this function, even in cases where there are two or more users who use the prescribed device, it is possible to carry out fine security control for each user. Here, note that in an embodiment of the present invention, the user identifiers that are input and set by the login function correspond to the users' names, respectively. When the position of the prescribed device in operation, for which security management is to be carried out, is detected, the name of a group to which the user concerned belongs is specified by the position of the prescribed device detected from the security information table and the user's name input upon logging in, so that a variety of security control can be carried out by the group name.

In a still further preferred form of the present invention, the security management apparatus further comprises a security information setting section inputting information to be stored in the security information storing section, or changing or deleting contents stored in said security information storing section.

With such a configuration, the security level of the prescribed device can be freely set so that it can be adapted to the condition of use thereof, the area of use thereof, etc., thus making it possible to perform fine security control to fulfill the user's desire. Incidentally, note that in an embodiment of the present invention, the security information table among the security information table storing information on security levels and the access right setting table is formed such that the user can specify the latitude and longitude of an area desired to be set by making a selection through a mouse or the like while using a GPS-enabled map, and input, change or delete the group name for the specified area. Also, the access right setting table can be edited such that the user can input, change or delete the access rights to desired files and/or programs for each group name. Such processing is performed through the table input section.

In a yet further preferred form of the present invention, the security levels each include an object on which security control is performed by the control unit, and a content of the security control. Preferably, the object on which security control is performed comprises at least one of files, folders, directories and programs handled by the prescribed device. The control content for each object may be a kind of an access right.

With the above configurations, it is possible to specifically set the kinds of access rights such as, for example, “read-only”, “changeable”, “nonaccessible”, etc., for files, folders, directories and programs, for example, which are usually accessed frequently in portable personal computers. As a result, the security of the computers can be strengthened.

In a further preferred form of the present invention, the security management apparatus is installed in the prescribed device. Thus, in cases where the apparatus is arranged in the prescribed device whose security is to be managed, it becomes easy to perform security control.

In a further preferred form of the present invention, the control unit comprises an OS, and the prescribed device comprises a personal computer. With this configuration, it is possible to easily carry out excellent security management for widely and generally used computers without the need of providing additional special hardware.

According to another aspect of the present invention, there is provided a security management method for the managing security of a prescribed device, the method comprising: detecting a position of the prescribed device; and controlling to change a security level of the prescribed device according to the position thereof detected in the position detecting step.

According to a further aspect of the present invention, there is provided a program for making a computer execute the above-mentioned method. In addition, by performing the above control step by means of an OS of the computer, it is possible to make the computer easily execute the security management according to the position thereof only by installing a small-capacity application for executing the remaining steps other than the control step.

According to a still further aspect of the present invention, there is provided a data storage medium readable by a computer in which positions and security levels of a prescribed device are stored in association with each other in order to carry out the above-mentioned security management of the prescribed device. Preferably, such a data storage medium may be accommodated in a computer in such a manner that it can be referred to by the OS of the computer. With this configuration, it is possible to make the computer perform the security management with ease. Preferably, the data recorded on the storage medium may be variable so that the security management can be done with excellent usability. Further, it is preferable that a program capable of inputting, deleting and changing such data be stored in the computer. This serves to further improve user's convenience.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a block diagram of a security management apparatus according to one embodiment of the present invention.

FIG. 2 shows a configuration example of a portable personal computer to which the security management apparatus according to the embodiment of the present invention is applied.

FIG. 3 is one example of a security information table according to the present invention.

FIG. 4 is one example of an access right setting table according to the present invention.

FIG. 5 is one half of a flow chart of security management according to the present invention.

FIG. 6 is the other half of the flow chart of the security management according to the present invention.

FIG. 7 is an example of a pop up message displayed when power is turned off.

FIG. 8 is an example of a pop up message displayed at the time of access right changing processing.

FIG. 9 is an example of an input screen for the security information table.

FIG. 10 is a view illustrating one example of the longitude and latitude of a position range (a company premises, a commutation route, and user's home) input on a setting input screen for the security information table.

### DESCRIPTION OF THE PREFERRED EMBODIMENTS

Hereinafter, preferred embodiments of the present invention will be described in detail while referring to the accompanying drawings.

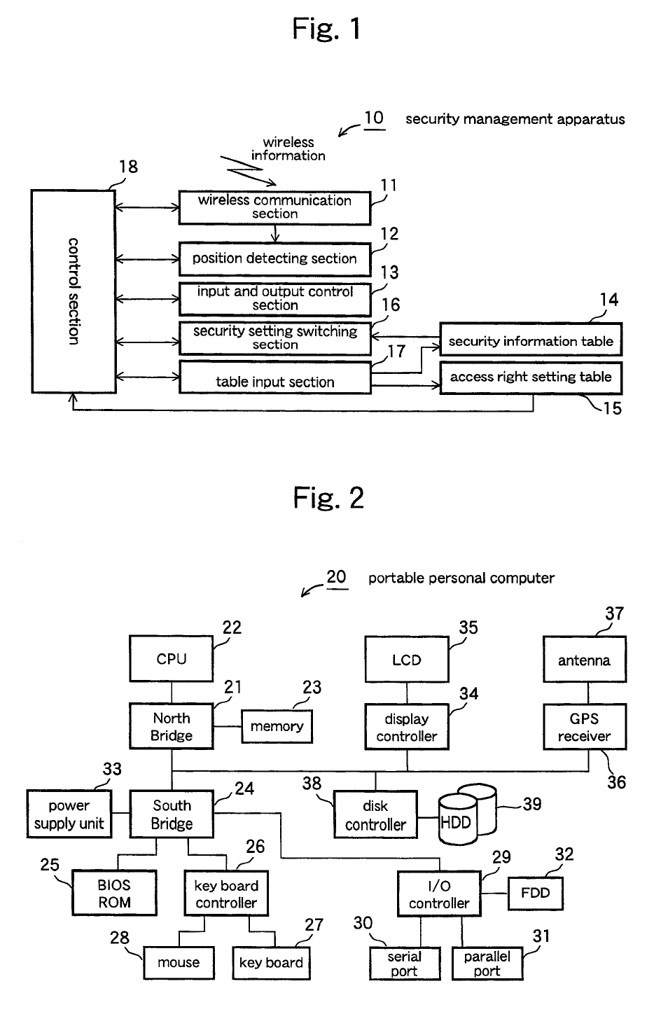

FIG. 1 is a block diagram illustrating the basic configuration of a security management apparatus in accordance with the present invention. In this embodiment, the security management apparatus detects the position of a device (e.g., the security management apparatus itself in this example) to be managed, and performs control on access rights to various objects (files, folders, etc.) inside the security management apparatus in accordance with the detected position.

In FIG. 1, the security management apparatus, generally designated at reference numeral 10 (hereinafter simply referred to as an apparatus 10) includes a wireless communication section 11 for performing wireless communications, a position detecting section 12 in the form of a position detector for detecting the current position of the apparatus 10 from the information acquired through wireless communications, an I/O control section 13 for performing login control upon booting of the apparatus 10 as well as various kinds of input and output control, a security information table 14 for storing geographical positions, user-names, and security-related information corresponding thereto, an access right setting table 15 for storing information on files, folders, programs, etc., and access rights corresponding to these respective items, a security setting switching section 16 for retrieving security-related information corresponding to the current position of the apparatus 10 from the security information table 14 thereby to switch between security settings, a table input section 17 for inputting and editing information to and in the security information table 14 and the access right setting table 15, and a control section 18 for controlling the overall function of the apparatus 10 and performing access control on programs, files, etc., based on security settings made by the security setting switching section 16.

FIG. 2 is a configuration example of a portable personal computer 20 to which the apparatus 10 shown in FIG. 1 is applied. The portable personal computer 20 includes a north bridge 21, a CPU 22 connected to the north bridge 21, and a memory 23. In addition, the portable personal computer 20 further includes a south bridge 24 connected to the north bridge 21, a BIOS ROM 25 connected to the south bridge 24 and storing a basic input/output system (BIOS), a keyboard controller 26, a keyboard 27 and a mouse 28 both connected to the key board controller 26, an I/O controller 29, a serial port 30 and a parallel port 31 both connected to the I/O controller 29, a floppy disk drive (FDD) 32, and a power supply unit 33. Here, note that a device having a serial interface or a parallel interface can be connected with the serial port 30 or the parallel port 31, respectively.

In addition, the portable personal computer 20 further includes a display controller 34, a liquid crystal display (LCD) 35 connected to the display controller 34, a global positioning system (GPS) receiver 36 acting as a position detecting section, an antenna 37 connected with the GPS receiver 36 for receiving radio waves from satellites, a disk controller 38, and a hard disk drive (HDD) 39 connected to the disk controller 38.

In the construction as referred to above, the wireless communication section 11 shown in FIG. 1 is mainly comprised of the antenna 37 and the GPS receiver 36 in FIG. 2, and the position detecting section 12 is mainly comprised of the GPS receiver 36. Moreover, the I/O control section 13 in FIG. 1 is comprised of an operating system (OS) stored in the HDD 39 in FIG. 2. In addition, the control section 18 in FIG. 1 is comprised of the CPU 22 in FIG. 2, and performs, upon implementation of the present invention, various control processing according to the OS and specific application programs (hereinafter simply referred to as applications) stored in the HDD 39. Further, the security setting switching section 16 and the table input section 17 are parts of the setting functions provided to the applications concerned separately from the control functions of the applications.

Now, reference will be made to the operation of this embodiment as constructed above. The control section 18 periodically outputs a control signal for acquiring the current position of the apparatus 10 to the position detecting section 12. The position detecting section 12, which has received the control signal from the control section 18, detects information on the current position of the apparatus 10 from the information received by the wireless communication section 11 through wireless communications. In this connection, note that the detection of the current position of the apparatus 10 may be made by using GPS technology, as shown in FIG. 2, or by using positional information service technology such as a personal handyphone system (PHS), portable or cellular phones and so on. When such a positional information service technology is used, a PHS or a cellular phone, which can use this service, is employed in place of the GPS receiver 36 and the antenna 37 in FIG. 2. Here, note that such a PHS or cellular phone may be built into the computer 20, or may be connected with the computer 20 through a cable. In the position detection of the present invention, the kind of the system or the kind of the device as used is not limited in any manner.

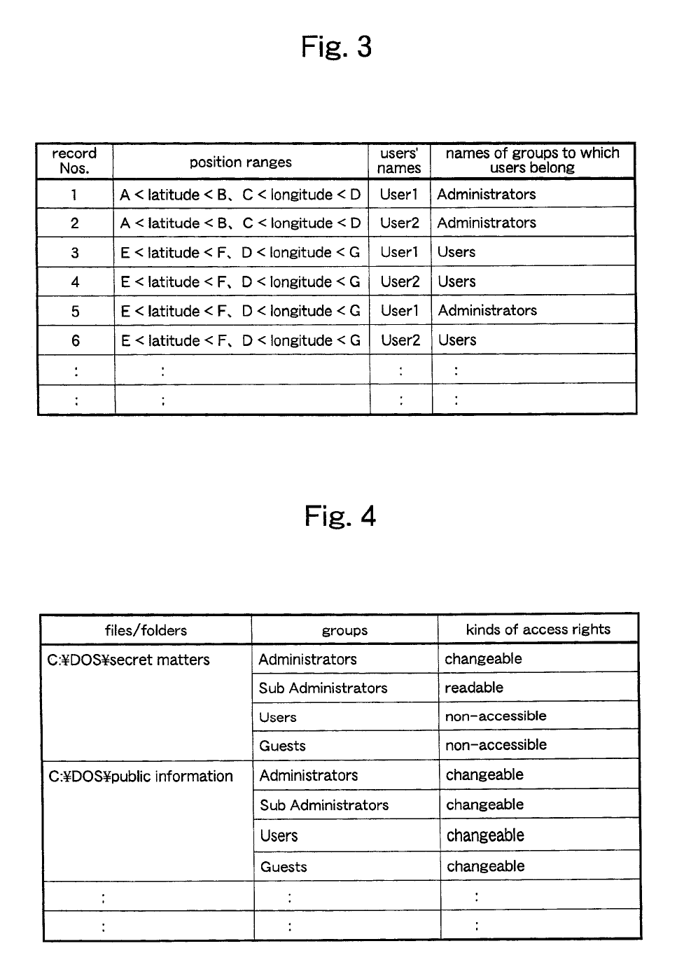

The position detecting section 12, which has detected information on the current position of the apparatus 10 from the information received through wireless communications, passes the position information thus detected to the security setting switching section 16 through the control section 18. The security setting switching section 16 having received the current position information from the position detecting section 12 acquires security-related information corresponding to the current position by referring to the security information table 14. Incidentally, note that the security information table 14 is stored in the HDD 39 which is controlled by the disk controller 38 in FIG. 2. FIG. 3 is one example of the security information table 14. In this embodiment, the security-related information acquired by the security setting switching section 16 is “the name of a group to which the user belongs” (hereinafter simply referred to as a group name) that is specified from a “position range” and a “user name”. In this embodiment, when no group name corresponding to the current position and the logged-in user's name does not exist in the security information table 14, the power supply to the apparatus 10 is tuned off. The user can input information to, and edit, the security information table 14 as described later.

The security setting switching section 16 holds the group name acquired from the security information table 14 as a security setting value of the user who uses portable personal computer 20 concerned. The control section 18 acquires information on the access right corresponding to the set value concerned by referring to the access right setting table 15, and controls access to files, programs, etc. Here, note that the access right setting table 15 is held in the HDD 39 which is controlled by the disk controller 38 in FIG. 2. FIG. 4 is one example of the access right setting table 15. In this embodiment, when an access instruction is issued to a file or program by the user, the control section 18 refers to “the corresponding kind of the access right” from “the group name” of the user held as a set value in the access right setting table 15, and carries out the security management of the file or program to which the access instruction is issued, in accordance with “the kind of the access right”.

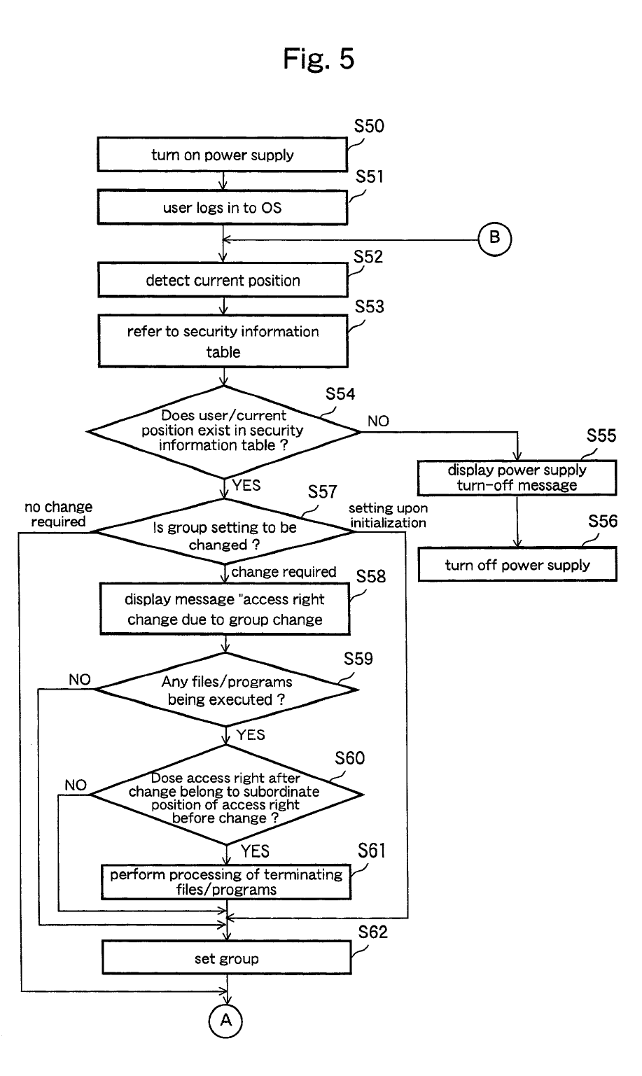

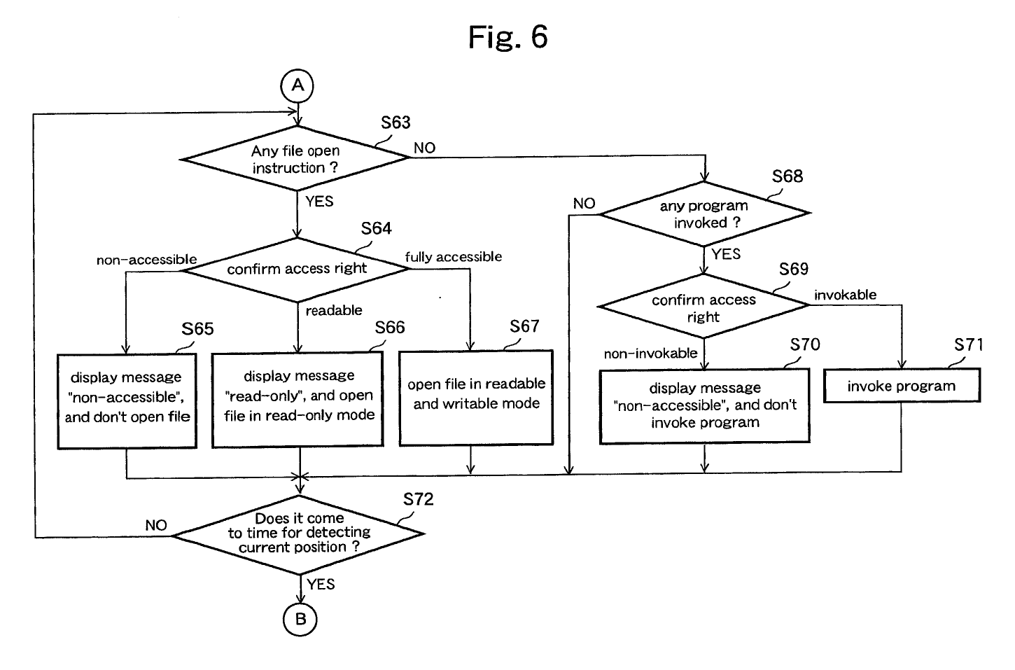

FIG. 5 and FIG. 6 are combined to form a complete flow chart of the security management including a change in the security settings and access control according to the present invention. Next, detailed reference will be made to the security management processing according to this embodiment while using these figures. Here, it is to be noted that the following description will proceed by dividing the processing of the control section 18 into the processing of the OS and the processing of applications.

First of all, when the user turns on the power supply for the apparatus 10 (in step S50), the OS is booted and the user logs in to the OS (in step S51). This login control is performed by the I/O control section 13 (OS), displaying a login screen for inputting a user's name. Then, login authentication processing is carried out by using the user's name input by the user. Here, note, however, that even if the login is completed, the apparatus is not made available to the user. After completion of the login, the current position of the apparatus 10 is detected by the position detecting section 12 (in step S52). Incidentally, note that in this embodiment, the detection of the current position of the apparatus 10 is carried out by an application periodically (e.g., at equal intervals, or immediately after logging in, or immediately after resuming, or the like).

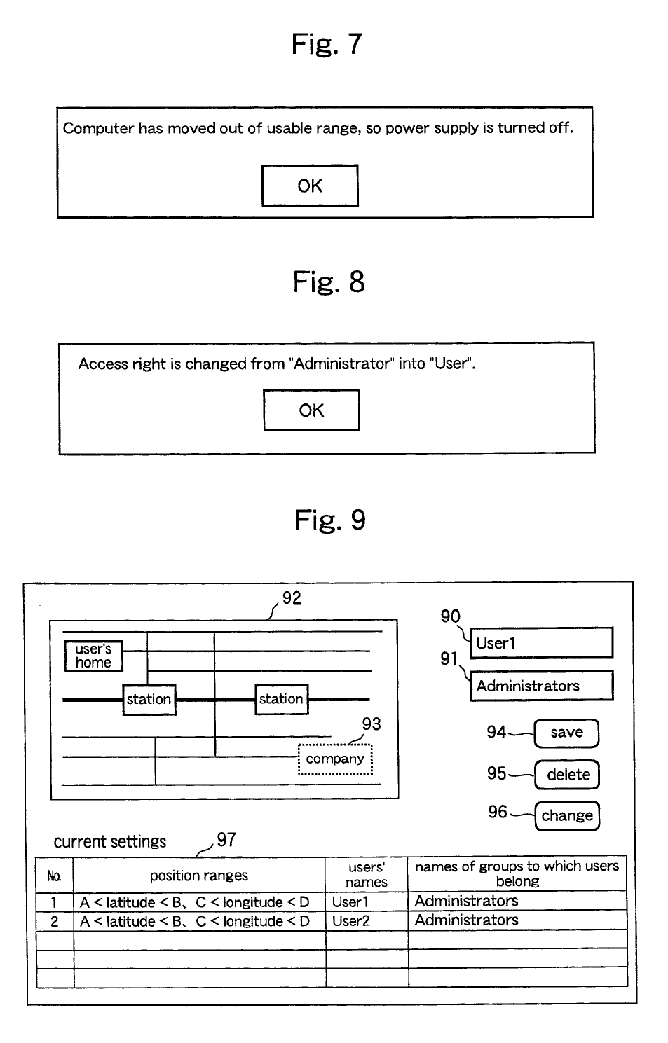

Next, the security setting switching section 16 makes reference as to whether the detected current position exists in the security information table 14, and whether the name of the user who has logged in exists in the same record in which the detected current position exists (in step S53). When there is no record in the security information table 14 where “the corresponding position range” concerned and “the user's name” of the login user are recorded (“NO”, in step S54), the application functions to display a power supply turn-off message (in step S55) and turn off the power supply (in step S56). FIG. 7 is an example of a pop up message displayed when the power supply is turned off. When an “OK” button in the pop up window is clicked by the user, the application performs the termination processing of the OS.

When there exists a record in the security information table 14 where “the corresponding position range” concerned and “the user's name” of the login user are recorded (“YES”, in step S54), the security setting switching section 16 acquires “the position range” and “a group name to which the user belongs” (hereinafter simply referred to as a group name) corresponding to “the user's name”. Here, if it is immediately after the apparatus 10 has been boosted (settings upon booting in step 857), the acquired group name is immediately assumed to be a set value because the name of the group to which the user belongs has not yet been set (in step S62). As a result, the apparatus 10 is placed into an available state.

After the group name has been set, the access control is performed based on the access right setting table 15. When a file open command is input by the user in FIG. 6 (“YES”, in step S63), the OS confirms the kind of the access right to the file corresponding to the file open command while referring to the access right setting table 15 (in step S64). When the kind of the access right is “non-accessible” (“non-accessible” in step S64), the OS displays a message indicative of “non-accessible”, and does not open the file (in step S65). On the other hand, when the kind of the access right is “readable” (“readable” in step S64), the OS displays a message indicative of the fact that the access right is “read only”, meaning “unable to edit the file”, and opens the file in a read-only mode (in step S66). When the kind of the access right is “editable” (“fully accessible” in step S64), the OS opens the file in a fully accessible mode for free reading and writing (in step S67). Even with folders or directories instead of files, if the kind of the access right is set to the access right setting table 15 beforehand as in the case of the files, it is possible to perform the access control.

When the instruction of the user is not a file open command (“NO” in step 363) but a program invoke command (“YES” in step S68), the OS confirms the kind of the access right to the program concerned while referring to the access right setting table 15 (in step S69). When the kind of the access right is “non-invokable” (“non-invokable” in step S69), the OS displays a message indicative of “non-accessible”, and does not invoke the program (in step S70). When the kind of the access right is “invokable” (“invokable” in step S69), the program is invoked (in step S71).

In this embodiment, the control of positional detection is performed besides the above-mentioned access control. When it comes to the time prescribed by the application beforehand (“YES” in step S72), the control process returns to the processing in step S52 of FIG. 5, where the current position of the apparatus 10 is detected. If otherwise (“NO” in step S72), the control process returns to the processing in step S63. In this embodiment, the positional detection is performed periodically (e.g., at equal intervals, or immediately after logging in, or immediately after resuming, etc.), and the detection intervals and timing can be set by the application.

Here, in cases where it is found as a result of the positional detection that the user, while using the apparatus 10, has moved to a position range in which the current position of the apparatus 10 does not exist in the security information table 14 (“NO” in step S54), the power supply turn-off (power-down) processing in steps S55 and S56 is performed as described above. However, when there is a file which is being edited by an editor application or the like at this time, a pop up window is displayed by a function of the editor application for determining whether or not the file being edited is saved, so that the user can execute the processing of saving the file or the like before the turning off of the power supply.

Moreover, when there arises the necessity of changing the setting of the group name due to the movement of the user (“change required” in step S57), the security setting switching section 16 displays a message indicative of the fact that the access right is changed by the group name change (in step S58). FIG. 8 is an example of the pop up message displayed upon the processing of changing the group name setting. When an “OK” button in the pop up window is clicked by the user, if there are files and/or programs under execution (“YES” in step S59), the OS confirms the access rights to the files and/or programs under execution by referring to the access right setting table 15. When the access right to the group name after the change belongs to a subordinate position of the access right to the group name before the change (“YES” in step S60), the OS carries out the processing of terminating the files and/or programs (in step S61). When there is a file which is being edited by an editor application or the like at this time, a pop up window (not shown) is displayed by a function of the editor application for determining whether or not the file being edited is saved, so that the user can execute the processing of saving the file or the like before the turning off of the power supply.

Thereafter, the security setting switching section 16 changes the setting of the name of the group to which the user belongs (in step S62), and the OS performs the access control as from step S63 to step S71 based on the change.

Here, note that when neither a file nor a program is being executed upon changing the group name setting (“NO” in step S59), a check is not made on the access right, but the setting change is immediately carried out (in step S62). In addition, even during execution of files and/or programs, when the access right after the change does not belong to a subordinate position of the access right before the change (“NO” in step S60), neither the files nor the programs under execution are terminated but the group name setting alone is changed (in step S62), thus permitting the user to continue working with the files and/or programs under execution.

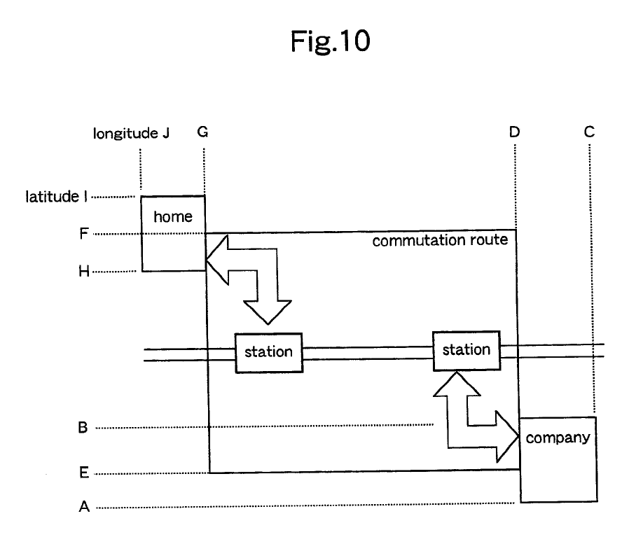

Next, concrete reference will be made to the details of the input processing and the associated access control to the security information table 14 and the access right setting table 15 according to an application while using FIG. 9 and FIG. 10. In this embodiment, it is assumed that the user (User1) sets group names by designating position ranges for a user's company, a user's commutation route, and a user's home, respectively, and performs security control. FIG. 9 is an example of an input screen for inputting positions, a user's name and a group name to the security information table 14. Also, FIG. 10 is a view showing the longitudes and latitudes of the position ranges of the user's company, the user's commutation route and the user's home which are input on the input screen for the security information table 14 shown in FIG. 9.

First of all, the user (User1) displays in advance an input screen shown in FIG. 9 by using a part of the functions of an application and the table input section 17, and sets the position ranges, the user's name and the name of the group to which the user belongs. In this embodiment, as shown in FIG. 9, the user inputs a user's name 90 and the name of a group 91 to which the user belongs, and selects a position range 93 to be set in a map 92 displayed on the screen, and clicks a save button 94, thus carrying out the addition of a setting.

Explaining now the above in accordance with the accompanying drawings, when the user (User1) makes selections of position ranges for the user's company, the user's commutation route and the user's home as shown in FIG. 10, the position ranges thus selected are as follows. That is, the user's company range: A<latitude<B, C<longitude<D; the user's commutation route, E<latitude<F, D<longitude<G; the user's home: H<latitude<I, G<longitude<J. For each of these position ranges, the user's name and the name of the group to which the user belongs are input and saved. For instance, if a setting is made in such a manner that the user (User1) belongs to a group of Administrators in the position ranges of the user's company and own home, and to a group of User in the position range of the commutation route, it is possible to perform access control in the user's company and own home and access control in the user's commutation route separately from each other. Incidentally, note that it is also possible to delete the above setting by using a delete button 95. Once the input setting has been done, it is added to a list of current settings 97, which is displayed.

When the screen is terminated, the input data is reflected on the security information table 14 as shown in FIG. 3. Here, in the case of the user (User1), the user's company corresponds to record No. 1, the user's commutation route corresponds to record No. 3, and the user's home corresponds to record No. 5. Further, the security information table 14 can be set for each of users, and as a result, in cases where a single portable personal computer is used by a plurality of users, it is possible to perform a position-based security setting in accordance with the condition of use of each user. Incidentally, it is also possible to respectively change the records already input by clicking a change button 96 in FIG. 9.

In this embodiment, the access right setting table 15 can be input and set by a function of the OS. According to this embodiment, a setting can be made in such a manner that the user can access the files and folders containing secret matters and so on in a readable and writable mode in the user's home and company, but can not access them in the user's commutation route. An illustration of the setting input screen for such a setting is omitted, but the result of the setting input is shown in FIG. 4. FIG. 4 is an example of setting the access rights to files and folders, in which settings such as “non-accessible”, “readable”, “changeable”, etc., are made according to the name of the group to which the user belongs.

When the set value (group name) is “Administrators”, it is possible to access both the folders “C:¥DOC¥secret matters” and “C:¥DOC¥public information” in a readable and writable mode, as shown in FIG. 4 (that is, the kind of the access right: “changeable”). On the other hand, when the set value (group name) is “Users”, the user can access the folder “C:¥DOC¥public information” in a readable and writable mode (that is, the kind of the access right: “changeable”), but cannot access the folder “C:¥DOC¥secret matters” (that is, the kind of the access right: “non-accessible”).

Here, note that the access right setting table 15 can set the kinds of the access rights not only for files and folders but also for programs. Moreover, similar settings are possible even with directories used with other OSs such as UNIX or the like.

In addition, although in this embodiment the access right setting table 15 is set and input by a function of the OS, it may be done by an application if the OS can refer to the settings of the access right setting table 15.

Now, a concrete example of the security control will be briefly described based on the above settings according to the flow charts of FIG. 5 and FIG. 6. First of all, the user turns on the power supply for the portable personal computer 20 in user's home (in step S50), and logs in to the OS under the user's name “User1” (in step S51). Immediately after the logging-in, the current position of the computer 20 is detected by an application (in step S52). In this case, the “position range” is: H<latitude<I and G<longitude<J. and the “user's name” is “User1”, so this case corresponds to record No. 5 in FIG. 3 (“YES” in step S54). As a result, it is set in such a manner that the user belongs to the group of “Administrators” (in step S62). Thus, in cases where the user (User1) is trying to access the folders “C:¥DOC¥secret matters” and “C:¥DOC¥public information” (“YES” in step S63), he or she can access these folders in a freely readable and writable mode (in step S67).

Next, in cases where the user is moving in order to go to his or her company or office, when the position of the computer 20 is detected after the user has moved into the range of the commutation route (i.e., E<latitude<F and D<longitude<G) (in step S52), it is set in such a manner that the user belongs to the group of “Users” because this case corresponds to record No. 3 in the security information table 14 in FIG. 3 (in step S62). Accordingly, the user can access the folder “C:¥DOC¥public information” in a freely readable and writable mode (in step S67), but can not access the folder “C:¥DOC¥secret matters” (in step S65).

Further, when the position of the computer 20 is detected after the user has moved into the company range (i.e., A<latitude<B and C<longitude<D) (in step S52), it is set such that the user belongs to the group of “Administrators” because this case corresponds to record No. 1 in the security information table 14 in FIG. 3 (in step S62). As a result, the user can access the folders “C:¥DOC¥secret matters” and “C:¥DOC¥public information” in a freely readable and writable mode (in step S67).

Although in this embodiment the security control is effected according to the place where the security management apparatus is located, the present invention can also be applied where a management apparatus and a device to be managed thereby are different from each other. In such a case, it is required, in addition to the components of the aforementioned embodiment, such an arrangement as to enable the transmission of information between the management apparatus and the device to be managed thereby, and another arrangement for enabling the device to be managed to perform control in accordance with instructions from the management apparatus. For example, such a modified embodiment is constructed as follows.

The management apparatus includes a position detecting section which may receive position information detected by the device to be managed itself, and recognize the current position of the device to be managed, or which may retrieve the device to be managed by using a positional information service and recognize the current position thereof.

Also, the device to be managed includes an I/O control section which notifies the management apparatus of a user's name input by the user upon logging in through wireless communications, etc., and the management apparatus has a function of receiving the user's name through wireless communications, etc.

In addition, the management apparatus further includes a security setting switching section which specifies a corresponding “group name to which the user belongs” by using the current position of the device to be managed and the user's name received from the device to be managed while referring to the security information table 14, and notifies the group name thus specified to the device to be managed. In the device to be managed, the group name is received from the management apparatus and set so that the access control is performed based on the access right setting table 15.

As described in the foregoing, according to the present invention, it can be made possible to boot an OS of a portable personal computer or to access files thereof when the computer is in a specific area or areas alone, whereas booting of the OS or access to the files of the computer can be made impossible when the portable personal computer has been moved out of the specific area(s). As a result, the security function of the portable personal computer can be improved. That is, it is possible to prevent the settings for security from being changed without relogging in to the OS, thus avoiding leakage of secret matters, which would otherwise be caused by user's opening a file containing the secret matters by mistake in a place where there are many third parties (e.g., in the user's commutation route in the above example).

In addition, by using the present invention, it becomes possible to prevent shoplifting of personal computers in computer shops, or theft of personal computers in event sites in which events are carried out with the personal computers being lent out.

Although a variety of embodiments of present invention have been described herein, it is needless to say that the present invention is of course not limited to such specific embodiments, but applicable to various forms of personal computers, other kinds of computers such as workstations, portable information equipment such as personal digital assistants (PDAs), dedicated or special-purpose terminals such as handy terminals, various kinds of devices such as game gears, cellular phones, et., without changing the technical concept of the present invention. Moreover, though in the above embodiments, various processing of the present invention has been performed by an OS and an application being run thereon, such processing may be carried out by an OS alone or an application alone while providing substantially the same effects.

What is claimed is:

1. A security management apparatus for managing the security of a prescribed device, said apparatus comprising: a position detecting section detecting a position of said prescribed device; and a control unit changing a security level of said prescribed device according to the position of said prescribed device detected by said position detecting section.

2. The security management apparatus according to claim 1, further comprising a security information storing section storing security levels of said prescribed device in association with positions of said prescribed device, wherein said control unit changes the security level of said prescribed device into one of the security levels stored in said security information storing section based on the position of prescribed device detected by said position detecting section.

3. The security management apparatus according to claim 2, wherein said security levels stored in said security information storing section are associated with users, and said control unit changes the security level of said prescribed device into one of the security levels stored in said security information storing section based on the position of said prescribed device detected by said position detecting section and one of said users.

4. The security management apparatus according to claim 3, wherein said apparatus has a login function capable of receiving and setting said users as corresponding user identifiers.

5. The security management apparatus according to claim 2, further comprising a security information setting section inputting information to be stored in said security information storing section, or changing or deleting contents stored in said security information storing section.

6. The security management apparatus according to claim 1, wherein said security levels each include an object on which security control is performed by said control unit, and a content of the security control.

7. The security management apparatus according to claim 6, wherein said object on which security control is performed comprises at least one of files, folders, directories and programs handled by said prescribed device.

8. The security management apparatus according to claim 6, wherein said content of security control on said object comprises a kind of an access right.

9. The security management apparatus according to claim 1, wherein said apparatus is installed in said prescribed device.

10. The security management apparatus according to claim 1, wherein said control unit comprises an OS, and said prescribed device comprises a personal computer.

11. A security management method for managing the security of a prescribed device, said method comprising: detecting a position of said prescribed device; and controlling to change a security level of said prescribed device according to the position thereof detected in said position detecting step.

12. A security management program for managing security of a prescribed device, said program adapted to make a computer execute detecting a position of said prescribed device, and controlling to change a security level of said prescribed device according to the position thereof detected in said position detecting step.

13. The security management program according to claim 12, wherein said control step is executed by an OS.

14. A program stored in a prescribed device for making, upon detection of a position of said prescribed device, a computer perform security control on said prescribed device while referring to security levels, which are stored in advance in association with positions of said prescribed device, based on said position of said prescribed device detected.

15. The program according to claim 14, wherein said program is an OS, and the security control of said prescribed device is performed as a part of functions of said OS.

16. A data storage medium readable by a computer, said medium storing data for the processing of managing the security of a prescribed device, said medium further storing positions and security levels of said prescribed device in association with each other, said security levels being information which is referred to based on a detected position of said predetermined device, whereby security control on said prescribed device is performed based on a result of the reference.

17. The data storage medium readable by a computer according to claim 16, wherein said positions and said security levels are variable.

18. A security level editing program for inputting or deleting or changing the information stored in said computer-readable data storage medium as set forth in claim 16.
